(19) United States
(12) Patent Application Publication
(10) Pub. No.: US 2016/0222701 A1
(43) Pub. Date: Aug. 4, 2016

(54) ADJUSTING UNIT FOR A MOTOR VEHICLE

(71) Applicant: KIEKERT AKTIENGESELLSCHAFT, Heiligenhaus, North Rhine-Westphalia (DE)

(72) Inventor: Sebastian Goldmann, Bochum (DE)

(21) Appl. No.: 14/907,996

(22) PCT Filed: Jul. 8, 2014
(86) PCT No.: PCT/DE2014/100232

§ 371 Date: Apr. 12, 2016

(30) Foreign Application Priority Data
Jul. 31, 2013 (DE) 10 2013 012 732.7

(51) Int. Cl. E05B 81/06; F16H 1/16; F16C 33/20

(52) U.S. Cl. CPC E05B 81/06; F16C 33/205; F16H 1/16

(57) ABSTRACT

The invention concerns an adjusting unit for automotive applications, in particular motor vehicle door closures or locking systems, with a housing, a drive disposed in the housing, in particular a worm gear, with an actuator which can be acted upon by the drive, and with at least one sliding bearing for accommodating a bearing point of the drive, in particular a worm of the worm gear. According to the invention, the adjusting unit comprises at least one sliding bearing which is provided in sections with an elastomer covering.

### BACKGROUND

The invention relates to an adjusting unit for automotive applications, in particular motor vehicle door closures or locking systems, with a housing, a drive arranged in the housing, in particular a worm gear with an actuator acted upon by the drive and at least one sliding bearing for accommodating a bearing point for the drive, in particular a worm of the worm gear.

Automotive applications use, in particular but not exclusively, drives for locking e.g. doors or flaps or fuel flaps. The applications contain drives which are referred to as micro drives due to the size of their motors and housing.

The technical solution described below relates, for instance, to a micro drive of a motor vehicle and, in particular to a worm gear for operating a side door and preferably a sliding door. As the drives are also able to change positions, the drive units are also referred to as adjusting units.

An adjusting unit with the described design is disclosed in DE 10 2009 036 835 A1 of the applicant. This invention is also based on a drive acting on an adjusting unit in a motor vehicle latch. The drive is also accommodated in a bearing point of the housing. This bearing point also consists of several parts. In the invention, the bearing point has been produced from a plastically easily deformable material, such as plastic. The invention refers, in particular, to a rubber bearing, containing a rubber bearing seat and a rubber ring.

DE 10 2011 107 634 A1 which is partly based on DE 10 2009 036 835 A1 contains a closer definition of a rubber bearing. The invention discloses a cylindrical rubber bearing, integrated in the housing in accommodating recesses, preventing rotation and essentially serving to secure the radial position, allowing tolerance compensation in relation to the gear unit.

In this case, the adjusting unit of the drive is designed as a linear adjusting unit and, in particular, as a spindle drive, used for acting upon a closing device. The closing device may be a device as disclosed, for instance, in DE 101 12 120 B4. Generally, a closing device in a latch ensures that it pulls a side door of a motor vehicle not fully engaged in the latch during closing towards it, so that the door fully engages in the latch.

The invention is also based on the prior art disclosed in property right DE 20 2006 009 003 U1. The document discloses a metal striker plate, covered by a damping material between the striker and striker plate in order to reduce engaging noises produced between the pawl and the striker plate. This material covers a hole and is made of plastic or more precisely of TPE.

Furthermore, DE 000 029 707 200 U1 discloses that also sliding bearings are deployed in door latches used in bathroom and cloakroom doors. Such a sliding bearing can be made of a plastic alloy where the housing is made of steel or aluminum.

The prior art disclosed in DE 10 2009 036 835 A1 and DE 20 2006 009 003 U1 is limited as regards the tolerances of the drive components. Due to excessive tolerances caused by wear or distortions resulting from stressing, the transfer of the rotary movement of the drive onto a gear unit or the adjusting unit, acted upon by the drive, can malfunction.

Inaccuracies at this point can indeed cause the gear unit or drive to generate excessive noise and/or excessive wear. The invention aims to remedy this.

### SUMMARY

The invention is based on the technical problem of further developing such an adjusting unit for automotive applications in such a way that the drive is aligned and the generated noise is reduced and malfunctioning is prevented or at least reduced to a minimum.

In order to solve this task, a generic adjusting unit for automotive applications is provided, in particular for motor vehicle door latches or locks, actuators, linear drives or winding and closing devices with a housing, with a drive arranged inside the housing, in particular a worm gear, with an adjusting unit acted upon by the drive and with at least one sliding bearing for accommodating a bearing point of the drive, in particular a worm of a worm gear drive, in which the sliding bearing also contains at least a plastic cover in certain areas.

The cover around the sliding bearing offers the option of compensating for tolerances during production, assembly or caused by wear. When using plastic, the plastic can, depending on the type selected, be adapted to the different requirements for the drive or the applied forces and moments.

The plastic can, for instance, be applied to the sliding bearing. In one embodiment, the plastic can, for instance be provided as strips on the sliding bearing, axially extending around its circumference. Alternatively, the plastic coating can be applied as radial, ring-shaped strips or as plastic spots. An application in zones offers a cost advantage and allows compensation for tolerances.

The sliding bearing is suited for guiding rotating components, such as a worm, which would not run smoothly without bearing, with uncontrolled rotating damaging the hole or bearing point and thus also the housing. At the same time, the bearing and its sheathing produces an adapted hold in the housing. As a result of the tolerance compensation it compensates in this case for a deviating, potentially oval hole. Such deviating holes can be the result of production or distortion. Tolerance compensation can be in axial and radial direction.

The used plastic is an advantageous material as it can be adapted to different surfaces and shapes. Injection molding allows application in areas of workpieces that are difficult to access, such as holes or angled bearing points. In addition, the sprayed-on plastic achieves optimum adhesion to the surface after solidification or cooling, irrespective of the unevenness of the surface or the nature of the material. Also, it is generally known that plastics are advantageous as they are freely available and easy to produce.

In addition, at least parts of an outer surface of the sliding bearing can be covered by elastomeric plastic. Plastic made from elastomer has the favorable characteristic of being soft and flexible. It is thus possible to provide a particularly smooth bearing for, for instance, a shaft or worm.

The plastic also offers damping characteristics which can, for instance, suppress a potential uncontrolled knocking and/or oscillating of a shaft. The sliding bearing also offers further advantages as regards production costs, as material costs are reduced as elastomeric layers are used sparingly on the sliding bearing sides, for instance on the inner or outer rings. As a result, also production time and consequently production costs can be reduced.

Another advantage is the sliding bearing as it contains an elastomeric sleeve around its circumference. The elastomeric layer consequently compensates for radial and axial deviations in the hole. As a result, unwanted play of the shaft or of the worm in the respective directions can be minimised. The resilient material also reduces vibrations.

Further advantages in production offer the option of the elastomer layer being injection molded onto the sliding bearing. Plastic injection molding allows quick completion of a production step of this sliding bearing combination and thus saves on production time and cost. This seamless connection offers a particularly uncomplicated connection due to the immediate adhesion after solidification of the compound. Unnecessary holes and/or complicated geometries, such as screws, bolts, pins or clamps are no longer required as connecting elements.

The sliding bearing is also accommodated in a housing and in particular in the housing of the motor vehicle door latch and preferably in the bearing hole or bearing seat. The result is a compact design of the drive as the bearing is arranged directly in the adjusting unit allowing for easy replacement of the adjusting unit. As the sliding bearing is installed in the housing of the adjusting unit, the sliding bearing is able to absorb and pass on considerable forces.

In addition, the sliding bearing can be made of plastic or a metal alloy. Both sliding bearing materials can be easily covered by a sheathing, in particular an elastomeric sheathing. A sliding bearing made of metal can, for instance, be used as it has a particularly long life compared to plastic bearings. A metal bearing also has better wear and strength characteristics. A plastic sliding bearing would be advantageous as it is less costly to produce and is preferred, in particular for shafts and axles with smaller diameters. A sliding bearing made of plastic also has a lower weight than a comparative metal bearing which is advantageous for light construction.

The sliding bearing also accommodates a drive shaft of the drive, preferably a shaft and even more preferably a worm shaft. The elastomer sheathing allows the sliding bearing to be adapted to the housing in the best possible manner as it compensates for unwanted play and thus guarantees a good seat, also benefitting the shaft located in the bearing. Optimum fit is ensured as it is secured in radial and axial direction. Knocking, wobbling or vibrating of the shaft is thus suppressed or avoided. Also, the installation of the shaft or of the worm is advantageous as the bearing is easily accessible from one side as it is located close to the surface of the housing. This allows easier use of the shaft or worm. For production, it is also possible to mount the sliding bearing and plastic sheathing directly onto the worm before being jointly inserted in the housing.

In another advantageous embodiment of the sliding bearing, the plastic sheathing of the sliding bearing is shaped like a pot so that the sliding bearing is covered in radial and axial direction. In addition to the aforementioned properties as regards damping characteristics, production of sheathing in form of a pot that does not only cover the side of the bearing, but also its face, is also favorable. The layer can thus be applied on the bearing in a single injection molding step without stopping.

The drive and the sliding bearing with a plastic sleeve are also rotationally symmetric in comparison to a common rotational symmetrical axis. This ensures a straight concentric guidance of the shaft or worm. A smoothly running shaft without knocking or similar contributes to the low-noise functioning of the unit.

The sliding bearing with plastic sleeve can also be advantageous as the plastic sleeve can be applied to the sliding bearing in different thicknesses. As a result, the sliding bearing is easily adaptable to deviating holes and/or shoulders and/or projections in the housing. Also tolerances in the finished sliding bearing as such can be compensated for.

The plastic sheathing can also have a different linear thickness in axial extension of the sliding bearing so that, in particular, a conical plastic sleeve can be achieved. As a result, the sliding bearing can be centrally fitted in a, for instance, tapered or conical hole. This offers advantages as regards an axial positional stability.

Another advantage may be derived from the plastic sheathing having a wave shape. As a result, a delicate surface of the shaft or worm can be protected on its entire circumference. The shaft could be inserted in the sliding bearing or possibly in the inner ring of the sliding bearing without clearance and at least without any angular deviation from the rotation axis.

Below, the invention is explained in detail with reference to one drawing, showing only one embodiment, in which:

### BRIEF DESCRIPTION OF THE DRAWINGS

FIG. 1 shows a side view of the installed sliding bearing in the latch housing, in which the sliding bearing accommodates a worm of the worm gear,

FIG. 2 shows a sectional view of the object of FIG. 1 in the area of the sliding bearing.

### DETAILED DESCRIPTION OF THE DRAWINGS

The figures show a side section of an adjusting unit for automotive applications. In the example, automotive applications relate to actuating functions for one or several motor vehicle doors 1, although the invention is not limited to this. The shown adjusting unit can actually be used to act on a closing device in such a motor vehicle latch 1, as disclosed, for instance, in DE 101 12 120 B4. This is naturally only an example and the invention is not limited to this.

In order to be able to produce the actuating movement or act on the closing device in the motor vehicle latch 1 as such, the basic design of the adjusting unit contains a controlling element or drive 2 and in particular a worm drive. The adjusting unit is acted upon by drive 2 in order to actuate the closing device on the motor vehicle door latch 1. The drive 2 can be controlled in different motor designs and similar and/or in respective intermediate gears.

The arrangement also contains a housing 3. The drive 2 is accommodated and arranged in the housing 3. The drive also contains a worm 6 and a worm gear 4. The worm 6 contains a top end of the worm 9, worm teeth 8 and a worm shaft 5. The worm teeth 8 of the worm 6 mesh with the teeth of the worm wheel 4. In this embodiment, the worm wheel 4 and the worm 6 are located on one plane.

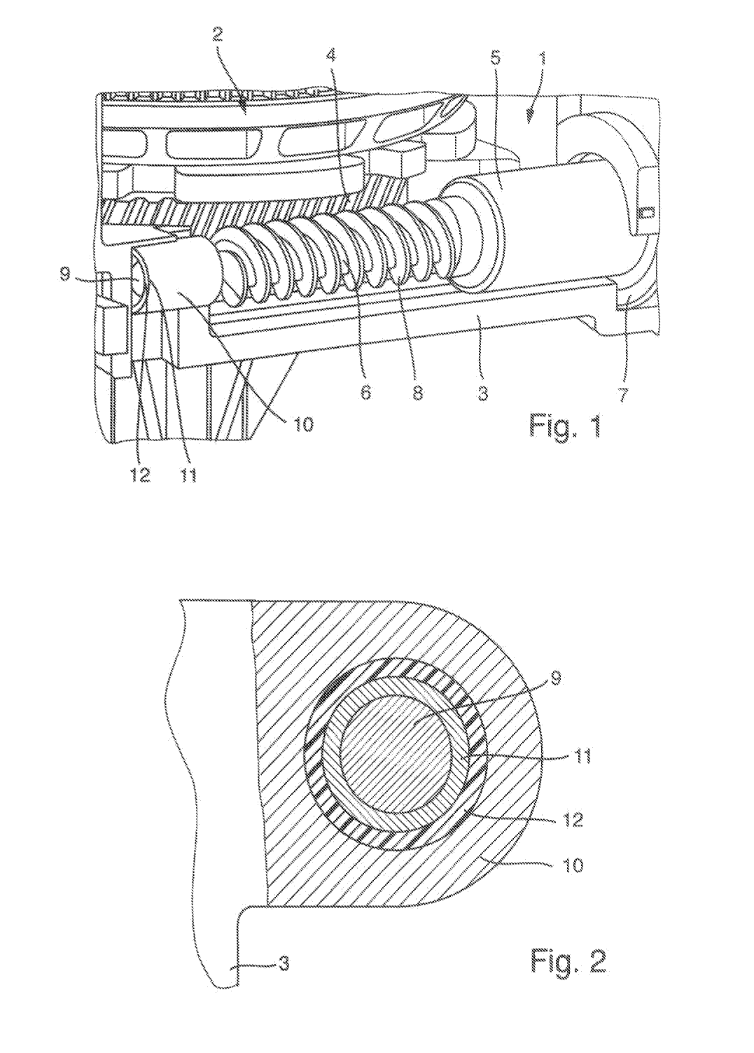

On the right of FIG. 1, one end of the worm shaft 5 of the worm 6 of the drive is positioned in the shaft bearing 7. Although only sections of the shaft bearing 7 are shown, the end of the worm shaft 5 is fully enclosed.

The other end of the worm 6 contains the top end of the worm 9. The top end of the worm 9 is accommodated in the sliding bearing 11. The sliding bearing 11 surrounds the top end of the worm 9 in its entirety so that the top end of the worm 9 cannot extend past the sliding bearing 11. Sliding bearing 11, worm 6 and shaft bearing 7 have a common centre line running centrally through the component centers. The top end of the worm 9 and the worm shaft 5 are preferably cylindrical.

The sliding bearing 11 is shown on the left in FIG. 1 and is arranged in a bearing seat 10. The bearing seat 10 is part of the housing 3 and can, in this embodiment, project laterally out of the housing 3 in form of a bulge. The bearing seat 10 is cylindrical, when viewed from the outside, and abuts against a surface of the housing 3. Preferably, the internal space of the bearing seat 10 is also cylindrical and is, even more preferably, a hole.

The bearing seat 10 can also be a separate component mounted on the housing 3.

The sliding bearing 11 is also cylindrical and is preferably made of plastic. The external surfaces of the sliding bearing 11 are also coated by an elastomer sheathing. 12.

In this embodiment, the elastomer sheathing 12 fully covers the lateral surface of the sliding bearing 11. Also, the face of the sliding bearing 11 is coated fully or at least partially by an elastomer plastic. The thickness of the elastomer sheathing 12 is freely variable and the elastomer sleeve 12 clings to the shape of housing 3 or the inside of the bearing seat 10.

In another embodiment of the sliding bearing 11—not shown—the elastomer sleeve 12 can be installed on the external surface inside the sliding bearing 11. The elastomer sheath 12 can, for instance, be in contact with the top end of the worm 9, as it physically separates the sliding bearing 11 from the worm 6.

1. Adjusting unit for automotive applications, in particular motor vehicle door closures or locking systems, with a housing, a drive arranged in the housing, with an actuator, in particular a worm gear, acted upon by a controlling element and at least one sliding bearing for accommodating a bearing point of the actuator, in particular a worm of the worm gear, characterized in that, at least in parts, the sliding bearing also contains a plastic sheathing.

2. Adjusting unit according to claim 1, characterized in that the sliding bearing has a cylindrical shape and that the plastic sheathing is applied onto a radial external surface.

3. Adjusting unit according to claim 1, characterized in that the plastic sheathing contains an elastomeric material.

4. Adjusting unit according to claim 1, characterized in that an elastomer layer is injection molded onto the sliding bearing.

5. Adjusting unit according to claim 1, characterized in that a sliding unit is accommodated in the housing in particular of a motor vehicle latch, in particular in a bearing hole or in a bearing seat.

6. Adjusting unit according to claim 1, characterized in that the sliding bearing is made of plastic or a metal material or, in particular, of an alloyed steel.

7. Adjusting unit according to claim 1, characterized in that a drive shaft of the controlling element, preferably a shaft and even more preferably a worm shaft are arranged in the sliding bearing.

8. Adjusting unit according to claim 1, characterized in that the plastic sheathing of the sliding bearing is pot-shaped so that the sliding bearing is radially and axially covered.

9. Adjusting unit according to claim 1, characterized in that the controlling element and the sliding bearing with the plastic sheathing are rotational symmetrical in relation to a common rotational symmetrical axis.

10. Adjusting unit according to claim 1, characterized in that the plastic sheathing is applied to the sliding bearing in different thicknesses.

11. Adjusting unit according to claim 10, characterized in that the plastic sheathing has a differing linear thickness in axial extension of the sliding bearing so that, in particular, a conical plastic sheathing can be provided.

12. Adjusting unit according to claim 10, characterized in that the plastic sheathing is wave shaped.
